(19) United States
(12) Patent Application Publication
(10) Pub. No.: US 2003/0028461 A1
(43) Pub. Date: Feb. 6, 2003

(54) System, apparatus, and method for making improved security trading decisions

(76) Inventor: Henry Von Kohorn, Vero Beach, FL (US)

Correspondence Address: PERMAN & GREEN, 425 POST ROAD, FAIRFIELD, CT, 06824, US

(21) Appl. No.: 09/921,347

(22) Filed: Aug. 2, 2001

(51) Int. Cl. G06F 17/60

(52) U.S. Cl. 705/36; 705/35

(57) ABSTRACT

A personal computer appliance programmed to provide an investor with means for integrating current market data into a customized structure comprised of an investor's personal investment parameters and for alerting the investor of a correlation of market data with selected parameters.

### FIELD OF THE INVENTION

The present invention is directed to a system and method for correlating custom investor-devised parameters with current security market data and thereby generating a sound basis for investment transactions.

### BACKGROUND OF THE INVENTION

With the advent of Internet trading, investors are becoming more independent in making investments. The ease with which security transactions can be accomplished is a mixed benefit, in that it encourages investment activity based on limited strategy and data. There is no longer a broker present to caution the investor against making risky or poorly considered trades. Although an individual investor may formulate their own parameters and parameters to support their trading, it is difficult to integrate market data into these custom parameters. The customized parameters may be as simple as a buy or sell price threshold or as complex as emerging market trends, confluence of market indicia, or ranges of parameters. It is a purpose of this invention to assist independent investors in formulating their custom parameters into a data base and for integrating market data into the customized data.

Modern communication technology has made current market data available on a moments notice from subscriber investment data bases through the Internet. Through cellular networks these sources are available virtually at any location and at any time. Microprocessors provide the computing power to handle complex mathematical functions in smaller packages. It is the purpose of this invention to provide a portable alerting in which the custom investment parameters may be stored, compared and processed with up to the minute market data.

### SUMMARY OF THE INVENTION

A small investment alert microcomputer is constructed having a memory, a processor having a comparison module, and an interface. A communications link, such as a cellular terminal, connects the alerting system to the Internet, local network or other centralized market data server, such as a subscription service, to access a source of up to date securities market data. The interface is designed to allow the user to input his/her investment parameters in a customized format to allow the ready integration of market data. The interface would include an appropriate keyboard to input data and a display or other mechanism to provide menus and information back to the investor. The comparison module will compare user-entered data to market data and the processor will generate an alert advisory when the preconceived parameters, integrated with current market data, provide a basis for a particular transaction. The advisory signal can be transmitted via a cellular network to the investor wherever he or she is located, or directly to a broker, in the event of a parameter that requires immediate attention. The communication module also allows the investor to contact his or her broker or other transaction service.

The investor, in using the system of this invention, formulates his or her own basis for independent investment transactions. The basic parameters, that are devised and inputted, support algorithms which integrate market data and compares such data to the user entered parameters. Advisories are generated to keep the investor abreast of market status, relating to investor parameters. By inputting ranges of values or transactional thresholds, advisories can be generated to indicate the particular transaction that may be beneficial.

### DESCRIPTION OF THE DRAWINGS

The present invention will now be described by way of example with reference to the accompanying drawings, wherein like reference numerals refer to like elements, and in which:

FIG. 1 is a block diagram of the investment alert system of this invention; and

FIG. 2 is a block diagram showing the method of this invention.

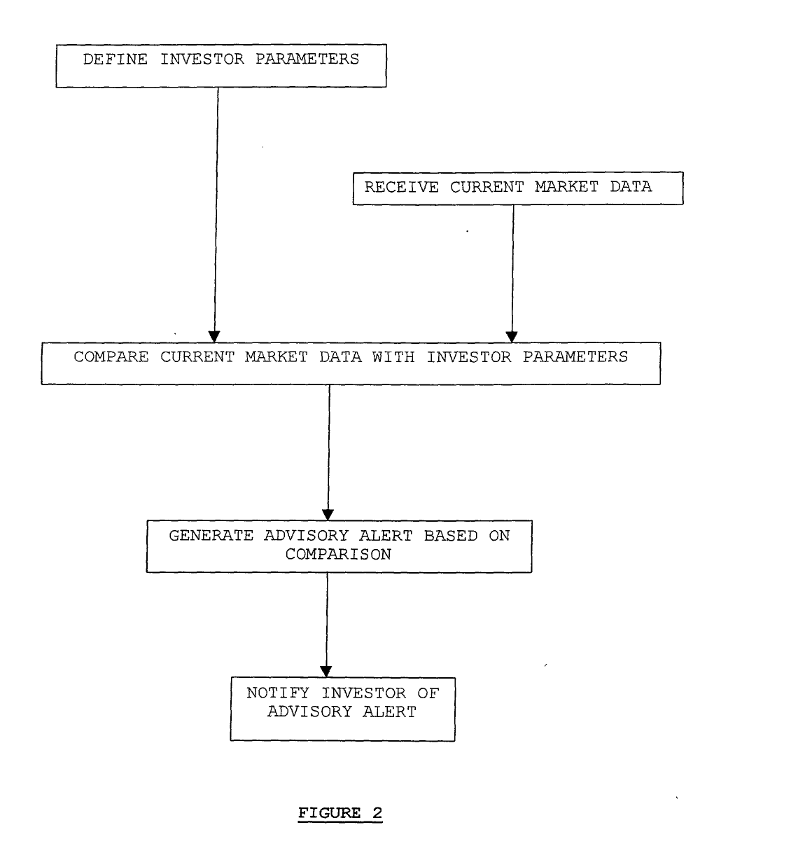

### DESCRIPTION OF THE PREFERRED EMBODIMENT

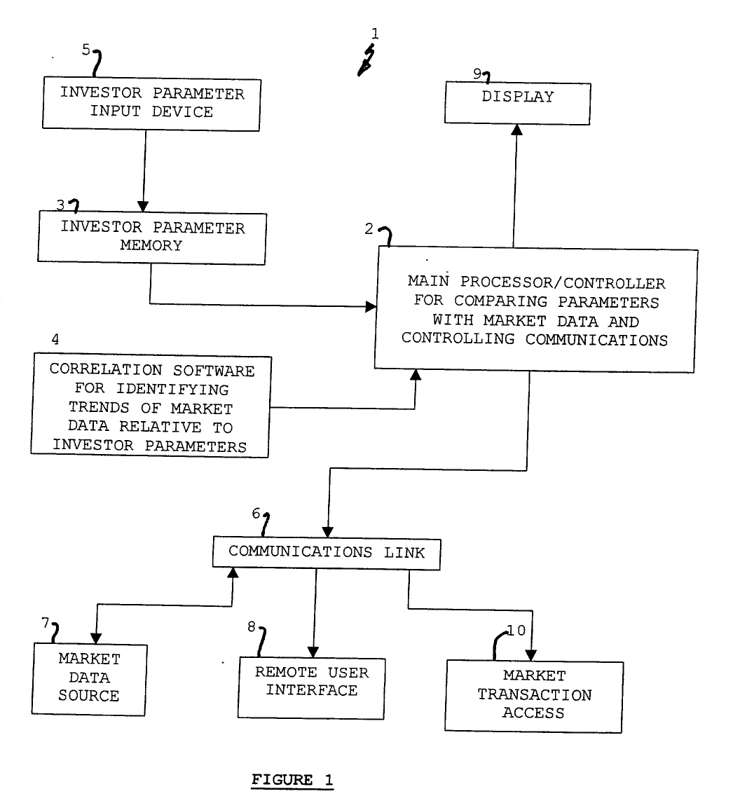

As shown in FIG. 1, the system of this invention consists of a computerized system embodied in a stand alone appliance 1 having a microprocessor 2. The microprocessor 2 includes memory 3 and is controlled by integrating software 4. An inputting device 5, such as a keyboard or keypad (not shown) allows the investor to enter data relating to the investor's custom investment parameters. A communication link 6, such as a telephone cable or cellular network allows the processor 2 to access a source of market data 7, such as an Internet stock market data subscription service. The communication link 6 could also access a remote user interface 8, such as a cellular telephone to provide instant transmission of advisory alerts.

Information may be retrieved by the investor by means of a display 9 or the remote interface 8. Link 6 also provides a direct access link 10 to a broker or other service for initiating a transaction.

The investor first formulates his or her parameters that are to be relied upon to support investment transaction decisions in specific stocks, securities, or groups of stock and securities. The parameters can include parameters and share indices, such as price/earnings ratios, historic low/high market price, and price trends, gross revenue performance, after tax profits, dividends paid, industry performance, share price rise and drop, short sale of shares, bond ratings and yields, debt ratings, etc. These parameters or factors may be assigned weights, arranged by ranges, trend direction, confluence of parameters, relative thresholds and other means depending on the strategy of the particular investor. The parameters provide a structure for the organization of market data for each investor. The evaluation of market data will therefore be customized to suit the purpose of the particular investor. A personalized computer advisory alert is therefore obtained that supports rational investments decisions in the absence of a qualified advisor.

Once the parameters are entered into the personal investment advisory alert appliance of this invention, the software 4 will cause processor 2 to update market data through communications link 6. This can be accomplished automatically or by the user at will. Software 4 will then cause processor 2 to organize the market data within the inputted investment parameter structure and compare current market data to user's parameters. This data can be accessed by the investor periodically to support his trading practice.

When the current market data correlates with a parameter, an advisory prompt can be initiated by processor 2 correlated to a particular transaction in a specific stock or groups of stock. An alarm can sound or appear on the display 9, to obtain the investor's attention and provide an opportunity for the investor to take immediate advantage of the advisory alert. The advisory may take the form of a recommended transaction and could be communicated directly to a broker for action if the urgency warranted immediate action.

The algorithm which controls the processor 2 is constructed to determine when market data is trending towards a parameter and identify stages, as the market data approaches the user entered data. The advisory alerts may also be generated to reflect the stage of the trend with gradually increasing urgency as the market data approaches full correlation with a single or group of investor parameters. For example, the visual alerts could start at a yellow alert and progress to red alerts at or near correlation.

Elements of the system of this invention are contained within a housing configured to be placed in a convenient location, for example, in close proximity to the investor. The apparatus can be adapted to be placed on the investor's lap, or on an armrest, a nearby counter or table, or at other locations making it easy for the investor to reach the input device and to enter, delete, or modify indicators, for example, while watching a market “ticker” on a TV or Internet screen, or while listening to market news on the radio.

In this manner a simple appliance is provided to organize and employ an investment strategy in support of independent investor transactions with less reliance on emotional or spontaneous urges.

I claim:

1. A system for formulating investment data to support an investor in the process of making investment transaction decisions comprising:
an input device to allow said investor to enter selected investment parameters in a memory;
a memory connected to said input device to receive and store said parameters;
a source of current investment data accessible by a communication link;
a communication link connected to provide access to a source of current market data;
a processor, operated by software, to receive market data via said communication link and compare said market data with said selected investor parameters and further to generate investment advisory alerts based on the correlation between market data and investor parameters; and
a user interface connected to said processor for communicating advisory alerts to said investor.

2. A system for formulating investment data to support an investor in the process of making investment transaction decisions, as described in claim 1, wherein the source of current market data is an Internet site.

3. A system for formulating investment data to support an investor in the process of making investment transaction decisions, as described in claim 1, wherein said communication link further comprises a communication link to a service for completing an investment transaction.

4. A system for formulating investment data to support an investor in the process of making investment transaction decisions, as described in claim 1, wherein said software allows said user to enter threshold parameter values related to a particular transaction and said processor operates to compare said threshold parameter values with the market data, to determine a correlation, and to generate an advisory alert supporting a buy or sell transaction.

5. A system for formulating investment data to support an investor in the process of making investment transaction decisions, as described in claim 1, further comprising a remote user interface connected to the communications module to allow for the entry of parameters and reception of to advisory alerts when the user is at a remote location.

6. A system for formulating investment data to support an investor in the process of making investment transaction decisions, as described in claim 5, wherein the remote user interface is constructed as part of a cellular telephone.

7. A system for formulating investment data to support an investor in the process of making investment transaction decisions, as described in claim 1, wherein said system is contained within a portable unit.

8. In a personal computing appliance having a processor, a memory, an input device, a user interface, and a communications link, a method for supporting investment decisions comprising the steps of:
defining investor parameters for evaluation in considering investment transactions, and entering said parameters into said memory;
receiving current market data via said communications link;
comparing said current market data with said investor parameters;
generating an advisory alert based on said comparison; and
notifying said investor of said advisory alert via said user interface.

9. In a personal computing appliance having a processor, a memory, an input device, a user interface, and a communications link, a method for supporting investment decisions, as described in claim 7, wherein the step of notifying said investor of said advisory alert is transmitted via said communications link to a remote user interface.

10. In a personal computing appliance having a processor, a memory, an input device, a user interface, and a communications link, a method for supporting investment decisions, as described in claim 7, further comprising the step of contacting a transaction service via said communication link to execute a transaction.

11. In a personal computing appliance having a processor, a memory, an input device, a user interface, and a communications link, a method for supporting investment decisions, as described in claim 7, wherein the step of receiving current market data via said communications link is accomplished by accessing an Internet source of current market data.

12. A system for formulating investment data to support an investor in the process of making investment transaction decisions, as described in claim 1, further comprising a housing adapted to accommodate said elements of the system and configured to be located within easy reach of the investor.

13. A system for formulating investment data to support an investor in the process of making investment transaction decisions, as described in claim 1, wherein said processor software, operates to identify a trend of the market data as it approaches said investor parameters and to generate an advisory alert in response thereto.

14. A system for formulating investment data to support an investor in the process of making investment transaction decisions, as described in claim 13, wherein said processor software further operates to identify predetermined stages of said trend, as said market data approaches correlation with said investor parameters.

15. A system for formulating investment data to support an investor in the process of making investment transaction decisions, as described in claim 1, wherein said processor software further operates to generate advisory alerts with increasing urgency as correlation is approached.

16. A system for formulating investment data to support an investor in the process of making investment transaction decisions, as described in claim 1, wherein early approaches and trends are indicated by yellow alerts and substantially complete correlation is indicated by red alerts.
